(19) United States
(12) Patent Application Publication
(10) Pub. No.: US 2025/0297815 A1
(43) Pub. Date: Sep. 25, 2025

(54) HEAT TRANSFER STRUCTURE WITH IMPROVED THERMAL CONVECTION EFFECT AND THERMAL ENERGY STORAGE SYSTEM USING THE SAME

(71) Applicant: National Cheng Kung University, Tainan (TW)

(72) Inventors: Chih-Che Chueh, Tainan (TW); Shao-Che Hung, Tainan (TW)

(21) Appl. No.: 18/818,771

(22) Filed: Aug. 29, 2024

(30) Foreign Application Priority Data
Mar. 23, 2024 (TW) 113119195

(51) Int. Cl. F28F 1/12

(52) U.S. Cl. CPC F28F 1/12; F28F 2215/02; F28F 2215/10

(57) ABSTRACT

A heat transfer structure includes: a part close to a heat source, configured to receive thermal energy from the heat source; a part far away from the heat source, located opposite the part close to the heat source to form an accommodation space between the two parts; and a first-tier H-type fin provided in the accommodation space, which is adjacent to the part close to the heat source and connected to the part close to the heat source, and includes: a first right fin connected to the part close to the heat source; a first left fin connected to the part close to the heat source in such a way that the first left fin and the first right fin are located opposite each other in a left-right direction; and a first middle piece connecting the first left fin and the first right fin.

### CROSS REFERENCE

This non-provisional application claims priority of Taiwan Invention patent application Ser. No. 11/311,9195, filed on Mar. 23, 2024, the contents thereof are incorporated by reference herein.

### BACKGROUND OF THE INVENTION

### 1. Technical Field

The present invention relates to a heat transfer structure. More particularly, the invention relates to a heat transfer structure with an improved thermal convection effect and to a thermal energy storage system using the heat transfer structure.

### 2. Description of Related Art

In recent years, energy saving and carbon emissions reduction have become global trends, and various sources of clean energy (e.g., renewable energy and green energy) have been developed rapidly. Electric vehicles, therefore, have been increasingly popular and become the mainstream in the vehicle market, resulting in a huge demand for energy storage devices. Thermal energy storage (TES) systems, in particular, have attracted attention from a wide array of researchers due to their wide applicability in solar energy, thermal comfort of buildings, and industrial thermal management, among many other fields.

Existing thermal energy storage techniques can be divided into three major categories: sensible heat storage, thermochemical energy storage, and latent heat storage. Latent heat storage methods are generally very efficient and have drawn the market's attention because energy storage by such a method depends on changes not in temperature but in the state of a material.

Phase-change materials (PCM) for use in latent heat storage can store and release a large amount of energy during transition between a solid state and a liquid state and have therefore become a high-efficiency solution to reducing temperature fluctuations in renewable energy systems. However, the phase-change material used in a latent-heat thermal energy storage (LHTES) system generally has a relatively low thermal conductivity, which slows down melting and solidification and thus compromises the convenience and efficiency of use of the system, leading to a high operation cost that hinders actual industrial application. Accordingly, the market is now in pressing need of an effective solution for improving the low melting and solidification speed, and thereby shortening the phase transition time, of a phase-change material, in order to enhance the efficiency and convenience of use of an LHTES system that employs the material.

### BRIEF SUMMARY OF THE INVENTION

The primary objective of the present invention is to solve the foregoing problems by providing a heat transfer structure that has an improved thermal convection effect, wherein the heat transfer structure includes: a part close to a heat source, wherein the part close to the heat source is configured to receive thermal energy from the heat source; a part far away from the heat source, wherein the part far away from the heat source is located opposite the part close to the heat source such that an accommodation space is formed between the part far away from the heat source and the part close to the heat source; and a first-tier H-type fin provided in the accommodation space, wherein the first-tier H-type fin is adjacent to the part close to the heat source and is connected to the part close to the heat source, and the first-tier H-type fin includes: a first right fin connected to the part close to the heat source; a first left fin connected to the part close to the heat source in such a way that the first left fin and the first right fin are located opposite each other in a left-right direction; and a first middle piece connecting the first left fin and the first right fin.

The heat transfer structure may further include a second-tier H-type fin provided in the accommodation space and located opposite the first-tier H-type fin. The second-tier H-type fin is adjacent to the part far away from the heat source and is connected to the part far away from the heat source. The second-tier H-type fin is also connected to the first-tier H-type fin to form an H-type fin structure. The second-tier H-type fin includes: a second right fin connected to the part far away from the heat source; a second left fin connected to the part far away from the heat source in such a way that the second left fin and the second right fin are located opposite each other in the left-right direction; and a second middle piece connecting the second left fin and the second right fin.

The heat transfer structure may further include a connecting piece that connects the first-tier H-type fin and the second-tier H-type fin and is located between the first-tier H-type fin and the second-tier H-type fin such that the first-tier H-type fin, the connecting piece, and the second-tier H-type fin jointly form the H-type fin structure.

The heat transfer structure may further include: at least one first reinforcing piece that connects the first middle piece of the first-tier H-type fin and the part close to the heat source and is located between the first middle piece and the part close to the heat source; and/or at least one second reinforcing piece that connects the second middle piece of the second-tier H-type fin and the part far away from the heat source and is located between the second middle piece and the part far away from the heat source.

The heat transfer structure may be so designed that the length of the first middle piece is less than the length of the second middle piece, and/or that the distance between the orthographic projections of the second left fin and of the second right fin in a normal direction of, and onto, the part close to the heat source is greater than the distance between the orthographic projections of the first left fin and of the first right fin in the normal direction of, and onto, the part close to the heat source.

The heat transfer structure may be so designed that a first angle is formed between the first right fin of the first-tier H-type fin and the connecting piece, that a second angle is formed between the second right fin of the second-tier H-type fin and the connecting piece, and that the first angle is less than the second angle.

The heat transfer structure may be so designed that the part close to the heat source is an inner tube, that the part far away from the heat source is an outer tube, that the inner tube is provided in the outer tube, that an annular space is formed between the outer tube and the inner tube, that the H-type fin structure is provided in the annular space, that the outer tube and the inner tube share the same axis and are concentrically arranged, and that the outer tube and the inner tube jointly form a circular tube with concentric tube walls.

The heat transfer structure may include N first-tier H-type fins, N connecting pieces, and N second-tier H-type fins so as to form N H-type fin structures, where N is a positive integer greater than one.

The heat transfer structure may be so designed that a third angle is formed between the corresponding first right fin and first left fin of each two adjacent first-tier H-type fins, that a fourth angle is formed between the corresponding second right fin and second left fin of each two adjacent second-tier H-type fins, and that the third angle is greater than the fourth angle.

Another objective of the present invention is to provide a thermal energy storage device that includes: the heat transfer structure described above; and a phase-change material that is provided in the accommodation space between the part far away from the heat source and the part close to the heat source and is in contact with the first-tier H-type fin and the second-tier H-type fin.

The heat transfer structure provided by the present invention is such that the special design of the external shape of the H-type fin structure increases the area of contact for heat exchange, and that by arranging a plurality of such H-type fin structures between the concentric tube walls of a circular tube, relatively strong natural convection can be effectively generated to speed up the melting of a phase-change material and thereby solve the problems of a conventional latent-heat thermal energy storage system, namely slow natural convection and low efficiency in heating a phase-change material.

### BRIEF DESCRIPTION OF THE SEVERAL VIEWS OF THE DRAWINGS

FIG. 1A is a cross-sectional view of a heat transfer structure with an improved thermal convection effect according to the present invention.

FIG. 1B is a cross-sectional view of another heat transfer structure with an improved thermal convection effect according to the present invention.

FIG. 1C is a cross-sectional view of yet another heat transfer structure with an improved thermal convection effect according to the present invention.

FIG. 1D is a cross-sectional view of still another heat transfer structure with an improved thermal convection effect according to the present invention.

FIG. 2A is a cross-sectional view of a further heat transfer structure with an improved thermal convection effect according to the present invention.

FIG. 2B is a cross-sectional view of two adjacent H-type fin structures in the heat transfer structure in FIG. 2A.

FIG. 2C is a see-through perspective view of the heat transfer structure with an improved thermal convection effect shown in FIG. 2A.

FIG. 3 is a cross-sectional view of the structure of a thermal energy storage device according to the present invention.

FIG. 4 is a cross-sectional view of the structure of another thermal energy storage device according to the present invention.

FIG. 5 shows curves plotted for the present invention to represent the relationships between the speeds at which a phase-change material was melted and three different fin thicknesses, with the first angle and the second angle kept at fixed values.

FIG. 6 shows how certain properties varied with the ratio of the second angle to the first angle in case 1 of the present invention.

FIG. 7 shows how certain properties varied with the ratio of the second angle to the first angle in case 2 of the present invention.

FIG. 8A is a flow vector and temperature distribution diagram obtained through numerical simulations performed on the fin structures in FIG. 2B.

FIG. 8B is a liquid phase distribution diagram obtained through numerical simulations performed on the fin structures in FIG. 2B.

FIG. 9 shows curves that represent the relationships between the speeds at which a phase-change material was melted and different bending angles in case 1 and case 2 of the present invention.

FIG. 10 is a bar chart showing the total energy (Eₜₒₜₐₗ), mean power (Pₘ), and energy per unit mass (Eₘ) corresponding to each ratio in case 1 and case 2 of the present invention.

### DETAILED DESCRIPTION OF THE INVENTION

The advantages of the structures and functions of the present invention as well as the objectives of the invention will be described in more detail below with reference to specific embodiments in conjunction with the structures shown in the accompanying drawings to enable a thorough understanding.

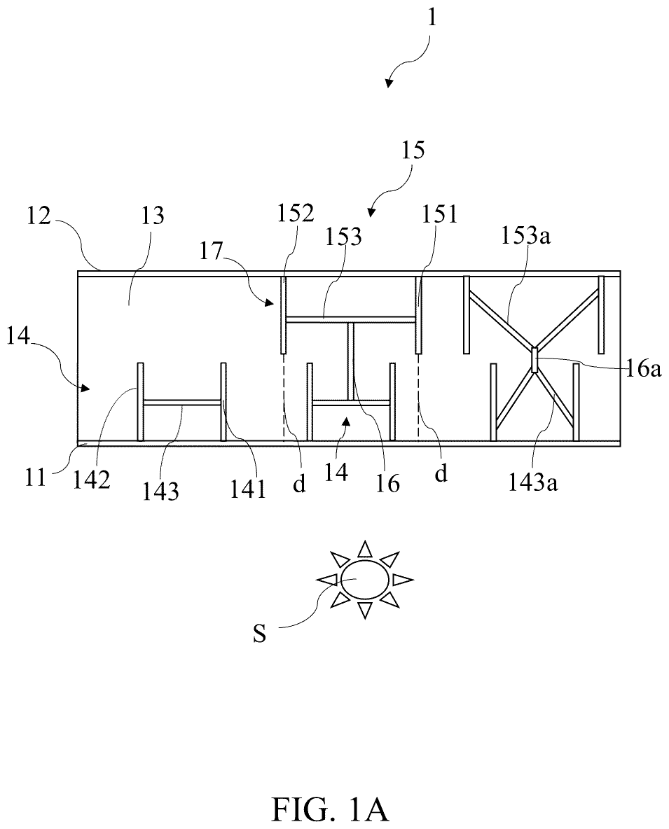

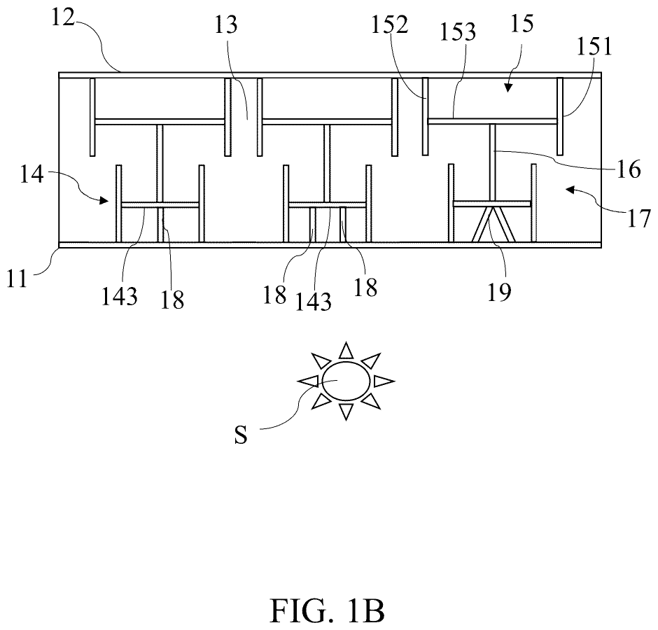

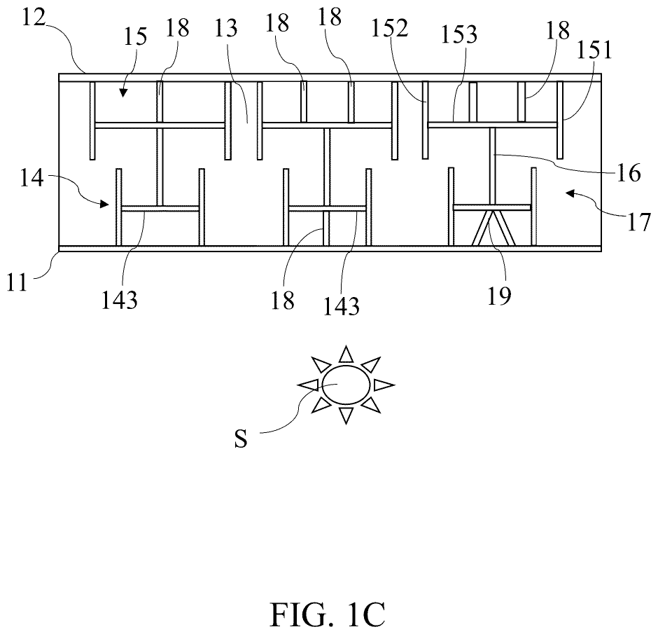

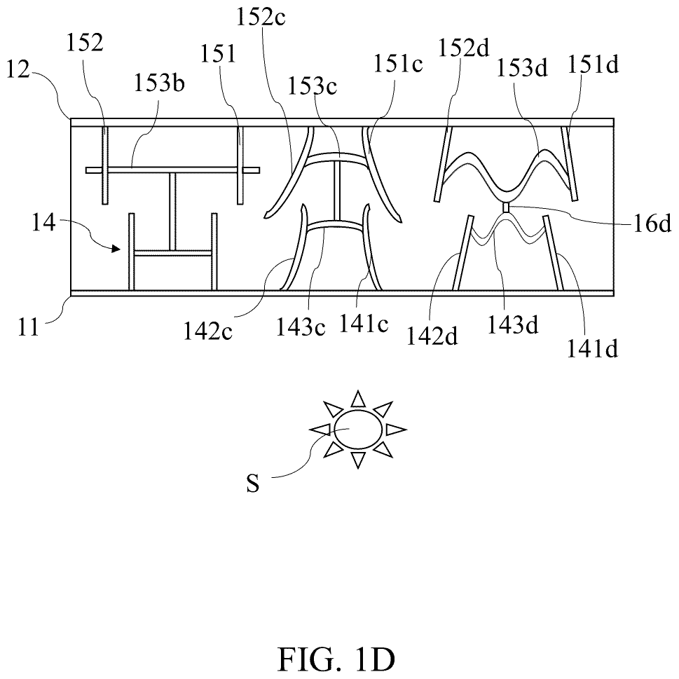

Referring to FIG. 1A, one mode of implementing the present invention brings about a heat transfer structure 1 that has an improved thermal convection effect. The heat transfer structure 1 includes: a part 11 close to a heat source S, wherein the part 11 close to the heat source S is configured to receive thermal energy from the heat source S; a part 12 far away from the heat source S, wherein the part 12 far away from the heat source S is located opposite the part 11 close to the heat source S such that an accommodation space 13 is formed between the part 12 far away from the heat source S and the part 11 close to the heat source S; and a first-tier H-type fin 14 provided in the accommodation space 13, wherein the first-tier H-type fin 14 is adjacent to the part 11 close to the heat source S, is connected to the part 11 close to the heat source S, and includes: a first right fin 141 connected to the part 11 close to the heat source S; a first left fin 142 connected to the part 11 close to the heat source S in such a way that the first left fin 142 and the first right fin 141 are located opposite each other in a left-right direction; and a first middle piece 143 connecting the first left fin 142 and the first right fin 141, wherein the first middle piece 143 extends along a length direction of the part 11 close to the heat source S to connect the first left fin 142 on the left and the first right fin 141 on the right. As the first-tier H-type fin 14 is provided on the part 11 close to the heat source S, the thermal energy received by the part 11 close to the heat source S can be transmitted directly to the first-tier H-type fin 14. Moreover, the external shape of the first-tier H-type fin 14 provides a large surface area for heat transfer so that, when the heat transfer surface of the first-tier H-type fin 14 contacts, and thereby exchanges heat with, the substance or material (e.g., a heat-absorbing material or cooling water) in the accommodation space 13, an improved thermal convection effect can be achieved.

In some embodiments, with continued reference to FIG. 1A, there may be a second-tier H-type fin 15 that extends upward from the first-tier H-type fin 14 and is provided in the accommodation space 13 and located opposite the first-tier H-type fin 14. The second-tier H-type fin 15 is adjacent to the part 12 far away from the heat source S, is connected to the part 12 far away from the heat source S, and includes: a second right fin 151 connected to the part 12 far away from the heat source S; a second left fin 152 connected to the part 12 far away from the heat source S in such a way that the second left fin 152 and the second right fin 151 are located opposite each other in the left-right direction; and a second middle piece 153 connecting the second left fin 152 and the second right fin 151, wherein the second middle piece 153 extends along a length direction of the part 12 far away from the heat source S to connect the second left fin 152 on the left and the second right fin 151 on the right. In addition, a connecting piece 16 is provided between the first-tier H-type fin 14 and the second-tier H-type fin 15 to connect the first-tier H-type fin 14 and the second-tier H-type fin 15. The first-tier H-type fin 14, the connecting piece 16, and the second-tier H-type fin 15 jointly form an H-type fin structure 17.

It can be understood that the elements of the first-tier H-type fin 14 and of the second-tier H-type fin 15 are not necessarily straight and may be curved. With continued reference to FIG. 1A, the present invention allows the second-tier H-type fin 15 to have a V-shaped second middle piece 153a and the first-tier H-type fin 14 to have an inverted V-shaped first middle piece 143a, wherein the first middle piece 143a and the second middle piece 153a are connected by a connecting piece 16a. When the length of the connecting piece 16a is reduced to such an extent that it approaches zero, the first-tier H-type fin 14 will have a generally W shape, and the second-tier H-type fin 15 will have a generally M shape. In other words, the H-type fin structure 17 may be a combined structure formed by connecting the first-tier H-type fin 14 directly to the second-tier H-type fin 15, and this is why the first middle piece 143 of the first-tier H-type fin 14 and the second middle piece 153 of the second-tier H-type fin 15 are not necessarily straight and may be circular arc-shaped or wavy. It can be understood that an equivalent change or modification in shape of the first middle piece 143 and of the second middle piece 153 may change the original H-shaped fin configuration into an N shape, an M shape, or a W shape. These derivative structural variants, however, generally do not depart from the H-shaped basic structure or design of the invention, which entails a left fin and a right fin that jointly define an accommodation space, and a middle piece provided in the accommodation space to connect the left fin and the right fin. That is to say, the invention has no limitation on the shape or position of each middle piece, and each middle piece may be straight, circular arc-shaped, or inclined. The middle pieces of the invention can be designed according to practical needs, thereby lending great flexibility to the actual design of the H-shaped fin configuration of the invention.

Referring to FIG. 1B, some embodiments may further include a reinforcing piece 18 that extends downward from the first-tier H-type fin 14, connects the first middle piece 143 of the first-tier H-type fin 14 and the part 11 close to the heat source S, is located between the first middle piece 143 and the part 11 close to the heat source S, and lies on the same straight line as the connecting piece 16 so as to form the first variant of the H-type fin structure 17. Alternatively, with continued reference to FIG. 1B, there may be two reinforcing pieces 18 that extend downward from the first-tier H-type fin 14, connect the first middle piece 143 of the first-tier H-type fin 14 and the part 11 close to the heat source S, are located between the first middle piece 143 and the part 11 close to the heat source S, and lie on different straight lines from the connecting piece 16 so as to form the second variant of the H-type fin structure 17. In some other embodiments, with continued reference to FIG. 1B, there may be a generally inverted-V shaped reinforcing fin 19 that extends downward from the first-tier H-type fin 14, connects the first middle piece 143 of the first-tier H-type fin 14 and the part 11 close to the heat source S, and is located between the first middle piece 143 and the part 11 close to the heat source S so as to form the third variant of the H-type fin structure 17.

In some embodiments, referring to FIG. 1C, the second-tier H-type fin 15 may, in a way similar to that described in the previous paragraph in relation to the first-tier H-type fin 14, include at least one reinforcing piece 18 that extends upward from the second-tier H-type fin 15, connects the second middle piece 153 of the second-tier H-type fin 15 and the part 12 far away from the heat source S, is located between the second middle piece 153 and the part 12 far away from the heat source S, and lies on the same straight line as the connecting piece 16 so as to form the fourth variant of the H-type fin structure 17. Alternatively, with continued reference to FIG. 1C, in the case that there is one reinforcing piece 18 extending downward from the first-tier H-type fin 14, there may be two additional reinforcing pieces 18 that extend upward from the second-tier H-type fin 15, connect the second middle piece 153 of the second-tier H-type fin 15 and the part 12 far away from the heat source S, and are located between the second middle piece 153 and the part 12 far away from the heat source S so as to form the fifth variant of the H-type fin structure 17. As another alternative, with continued reference to FIG. 1C, in the case that there is one reinforcing fin 19 extending downward from the first-tier H-type fin 14, there may be two reinforcing pieces 18 extending upward from the second-tier H-type fin 15 so as to form the sixth variant of the H-type fin structure 17. In other words, the present invention allows various structural designs to be derived from the basic configuration of the H-type fin structure 17.

The present invention also allows the elements of the basic configuration of the H-type fin structure 17 to vary in shape. In some embodiments, referring to FIG. 1D, the second middle piece 153b of the second-tier H-type fin 15 may extend beyond the second right fin 151 and the second left fin 152 so as to form the seventh variant of the H-type fin structure 17. Alternatively, with continued reference to FIG. 1D, the second right fin 151c, the second left fin 152c, and the second middle piece 153c of the second-tier H-type fin 15 may be curved, with the second right fin 151c and the second left fin 152c spaced further and further apart in a downward direction, and the first right fin 141c, the first left fin 142c, and the first middle piece 143c of the first-tier H-type fin 14 may also be curved, with the first right fin 141c and the first left fin 142c spaced further and further apart in the downward direction, too, so as to form the eighth variant of the H-type fin structure 17. As another alternative, with continued reference to FIG. 1D, the second middle piece 153d and the first middle piece 143d may have a wavy design while the first right fin 141d, the first left fin 142d, the second right fin 151d, and the second left fin 152d are inclined so as to form the ninth variant of the H-type fin structure 17. It can be understood that the length of the connecting piece 16d may be reduced to such an extent that it approaches zero, thereby allowing a low point of the wavy second middle piece 153d to be directly connected to a high point of the wavy first middle piece 143d so as to form the tenth variant of the H-type fin structure 17.

It can be understood that, referring back to FIG. 1A, the thermal energy received by the part 11 close to the heat source S can be directly transmitted, by thermal conduction, to the first-tier H-type fin 14 and then to the second-tier H-type fin 15 due to the fact that the second-tier H-type fin 15 is provided on the first-tier H-type fin 14. Such a double-tier H-type fin structure has a larger surface area for heat transfer than the first-tier H-type fin 14, which has only one tier, so when the heat transfer surfaces of the first-tier H-type fin 14 and of the second-tier H-type fin 15 contact, and thereby exchange heat with, the substance or material in the accommodation space 13, an improved thermal convection effect can be achieved.

Similarly, it can be understood that, referring back to FIG. 1B, the thermal energy received by the part 11 close to the heat source S can be directly transmitted, by thermal conduction, to the first-tier H-type fin 14 and the reinforcing piece(s) 18 or reinforcing fin 19 and then to the second-tier H-type fin 15 due to the fact that the reinforcing piece(s) 18 or reinforcing fin 19 is provided between the first-tier H-type fin 14 and the part 11 close to the heat source S, and in consequence, the thermal energy can be transmitted faster than without the reinforcing piece(s) 18 or reinforcing fin 19. Since such a double-tier H-type fin structure with the reinforcing piece(s) 18 or reinforcing fin 19 has a larger surface area for heat transfer than the first-tier H-type fin 14, which has only one tier, an improved thermal convection effect is equally achievable when this heat transfer surface contacts, and thus exchanges heat with, the substance or material in the accommodation space 13.

It is worth mentioning that, referring back to FIG. 1A, the present invention requires a significant temperature gradient to be formed between the part 11 close to the heat source S and the part 12 far away from the heat source S in order to improve thermal convection, and that to form this significant temperature gradient, it is necessary for the second-tier H-type fin 15 to have a larger overall volume, and hence a larger overall surface area, than the first-tier H-type fin 14. Therefore, the first middle piece 143 of the first-tier H-type fin 14 should have a shorter length than the second middle piece 153 of the second-tier H-type fin 15 to ensure that the volume occupied by, and the surface area of, the second-tier H-type fin 15 as a whole are greater than those of the first-tier H-type fin 14 as a whole.

In addition, the connecting piece 16, which connects the first-tier H-type fin 14 to the second-tier H-type fin 15, ensures that the path of thermal conduction between the first-tier H-type fin 14 and the second-tier H-type fin 15 is limited to the connecting piece 16 alone, and this makes it easier to form a significant temperature gradient between the first-tier H-type fin 14 and the second-tier H-type fin 15. Moreover, the second left fin 152 and the second right fin 151 of the second-tier H-type fin 15 are preferably located on the outer sides of the first left fin 142 and the first right fin 141 of the first-tier H-type fin 14 respectively, i.e., with the distance between the orthographic projections of the second left fin 152 and of the second right fin 151 in a normal direction d of, and onto, the part 11 close to the heat source S being greater than the distance between the orthographic projections of the first left fin 142 and of the first right fin 141 in the normal direction d of, and onto, the part 11 close to the heat source S, as shown in FIG. 1A. This design also makes it easier to form a significant temperature gradient between the first-tier H-type fin 14 and the second-tier H-type fin 15. In other words, the present invention allows various means to be used to form a significant temperature gradient between the part 11 close to the heat source S and the part 12 far away from the heat source S.

In the embodiments shown in FIG. 1A to FIG. 1D, the heat transfer structure 1 with an improved thermal convection effect is a plate-shaped structure. More specifically, both the part 11 close to the heat source S and the part 12 far away from the heat source S are metal panels, and the accommodation space 13 formed between the part 11 close to the heat source S and the part 12 far away from the heat source S is a space enclosed between the two metal panels and having a rectangular parallelepiped shape. The shapes of the part 11 close to the heat source S and of the part 12 far away from the heat source S, however, are not limited to the foregoing and can be changed to meet practical needs; for example, they may be arcuate, circular, concave, convex, circular arc-shaped, or of other shapes. A differently shaped heat transfer structure with an improved thermal convection effect according to an embodiment of the invention is described below.

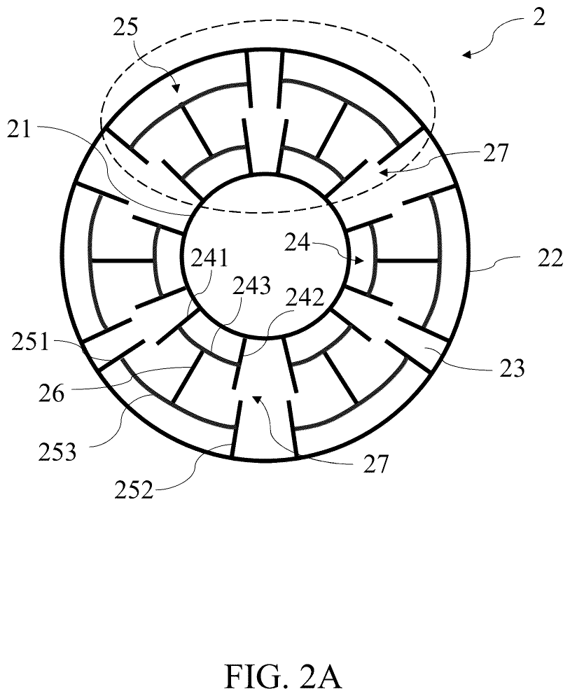

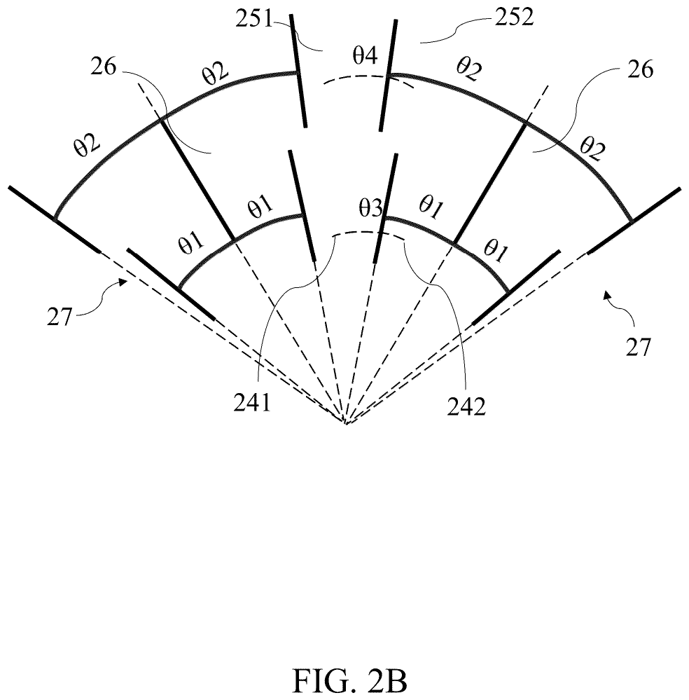

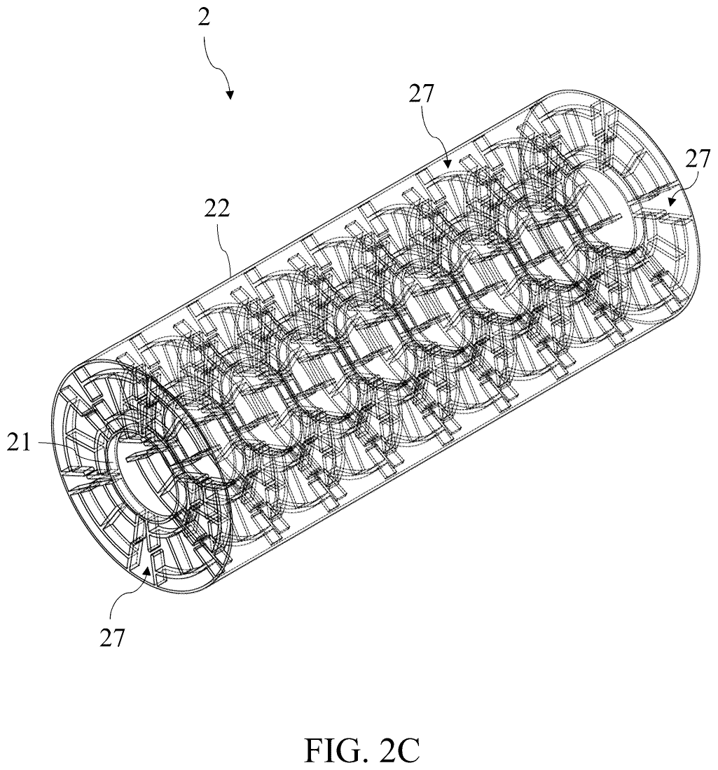

Referring to FIG. 2A and FIG. 2C, another mode of implementing the present invention brings about a heat transfer structure 2 that has an improved thermal convection effect. The heat transfer structure 2 is different from the heat transfer structure 1 in that the part 11 close to the heat source S and the part 12 far away from the heat source S are both changed into circular metal tubes. The heat transfer structure 2 includes: an inner tube 21 that, like the part 11 close to the heat source S, is configured to receive thermal energy; an outer tube 22 that, like the part 12 far away from the heat source S, is located opposite the inner tube 21 such that an accommodation space 23 is formed between the outer tube 22 and the inner tube 21, wherein the inner tube 21 has a smaller diameter than the outer tube 22, the inner tube 21 is provided in the outer tube 22, and the accommodation space 23 formed between the outer tube 22 and the inner tube 21 is an annular space; and a plurality of H-type fin structures 27 provided in the accommodation space 23, wherein the H-type fin structures 27 are provided in the annular space in such a way that they are arranged around, and in the circumferential direction of, the inner tube 21.

As shown in FIG. 2A, each H-type fin structure 27 in this embodiment also includes a first-tier H-type fin 24, a connecting piece 26, and a second-tier H-type fin 25, wherein the first-tier H-type fin 24 includes a first right fin 241 connected to the inner tube 21, a first left fin 242 connected to the inner tube 21 in such a way that the first left fin 242 and the first right fin 241 are located opposite each other in a left-right direction, and a first middle piece 243 extending along the circumferential direction of the inner tube 21 to connect the first left fin 242 on the left and the first right fin 241 on the right and therefore having a circular arc shape; wherein the second-tier H-type fin 25 includes a second right fin 251 connected to the outer tube 22, a second left fin 252 connected to the outer tube 22 in such a way that the second left fin 252 and the second right fin 251 are located opposite each other in the left-right direction, and a second middle piece 253 extending along the circumferential direction of the inner tube 21 to connect the second left fin 252 on the left and the second right fin 251 on the right and therefore having a circular arc shape; and wherein the connecting piece 26 connects the first-tier H-type fin 24 and the second-tier H-type fin 25 and is located between the first-tier H-type fin 24 and the second-tier H-type fin 25.

In this embodiment, the outer tube 22 and the inner tube 21 share the same axis, are arranged in a concentric manner, and therefore jointly form a circular tube that has concentric tube walls, and there are six H-type fin structures 27 arranged in a radiating manner in the annular space between the concentric tube walls of this circular tube structure. The number of the H-type fin structures 27, however, is not limited to six. In some embodiments, there may be N H-type fin structures 27 provided in the annular space, and the N H-type fin structures 27 include N first-tier H-type fins 24, N connecting pieces 26, and N second-tier H-type fins 25 and are each formed of one first-tier H-type fin 24, one connecting piece 26, and one second-tier H-type fin 25, where N is a positive integer greater than one. In some embodiments, the number of the N H-type fin structures 27 is in the range from two to nine, preferably in the range from three to six.

FIG. 2B is an enlarged view of two adjacent H-type fin structures 27 in the heat transfer structure 2 with an improved thermal convection effect in FIG. 2A (i.e., of the two H-type fin structures 27 in the dashed-line circle in FIG. 2A). Basically, all the H-type fin structures 27 have the same dimensions, and the left and right fins of the first-tier H-type fin 24 and of the second-tier H-type fin 25 of each H-type fin structure 27 are symmetrically provided with respect to the corresponding connecting piece 26. Therefore, a first angle θ1 is formed between the first left fin 242 of each first-tier H-type fin 24 and the corresponding connecting piece 26 as well as between the first right fin 241 of each first-tier H-type fin 24 and the corresponding connecting piece 26, and a second angle θ2 is formed between the second left fin 252 of each second-tier H-type fin 25 and the corresponding connecting piece 26 as well as between the second right fin 251 of each second-tier H-type fin 25 and the corresponding connecting piece 26.

In addition, a third angle θ3 is formed between the corresponding first left fin 242 and first right fin 241 of each two adjacent first-tier H-type fins 24, as shown in FIG. 2B, and the third angle θ3 can be determined by subtracting N times (which in this embodiment is 6, corresponding to the six H-type fin structures 27) the angle between the first right fin 241 and the first left fin 242 of each first-tier H-type fin 24 (i.e., two first angles θ1) from the central angle of the circumference of a circle (i.e., 360 degrees) and dividing the difference by N (which in this embodiment is also 6, corresponding to the six gaps between the six H-type fin structures 27), as mathematically expressed by θ3=(360°−2*θ1*N)/N, where θ3 is the third angle, θ1 is the first angle, and N is the number of the H-type fin structures 27.

Similarly, a fourth angle θ4 is formed between the corresponding second right fin 251 and second left fin 252 of each two adjacent second-tier H-type fins 25, as shown in FIG. 2B, and the fourth angle θ4 can be determined by subtracting N times (which in this embodiment is 6, corresponding to the six H-type fin structures 27) the angle between the second right fin 251 and the second left fin 252 of each second-tier H-type fin 25 (i.e., two second angles θ2) from the central angle of the circumference of a circle (i.e., 360 degrees) and dividing the difference by N (which in this embodiment is also 6, corresponding to the six gaps between the six H-type fin structures 27), as mathematically expressed by θ4=(360°−2*θ2*N)/N, where θ4 is the fourth angle, θ2 is the second angle, and N is the number of the H-type fin structures 27.

It can be understood from the foregoing explanation on thermal convection improvement that, in order for each second-tier H-type fin 25 to have a larger overall volume and surface area than the corresponding first-tier H-type fin 24, the first angle θ1 between the first right fin 241 of each first-tier H-type fin 24 and the corresponding connecting piece 26 must be less than the second angle θ2 between the second right fin 251 of the corresponding second-tier H-type fin 25 and the corresponding connecting piece 26. Similarly, the first angle θ1 between the first left fin 242 of each first-tier H-type fin 24 and the corresponding connecting piece 26 must also be less than the second angle θ2 between the second left fin 252 of the corresponding second-tier H-type fin 25 and the corresponding connecting piece 26. By the same token, the third angle θ3 between the corresponding first right fin 241 and first left fin 242 of each two adjacent first-tier H-type fins 24 must be greater than the fourth angle θ4 between the corresponding second right fin 251 and second left fin 252 of each two adjacent second-tier H-type fins 25.

In each H-type fin structure 27 in this embodiment, the length of the first right fin 241 is approximately equal to the length of the first left fin 242, the length of the first right fin 241 is approximately equal to the length of the second right fin 251, the length of the second right fin 251 is approximately equal to the length of the second left fin 252, the length of the first middle piece 243 is less than the length of the second middle piece 253, and the length of the connecting piece 26 is greater than the length of the first right fin 241. In addition, the first right fin 241 and the first left fin 242 of each first-tier H-type fin 24 extend from the inner tube 21 in a radial direction thereof toward the outer tube 22 into the accommodation space 23, and the second right fin 251 and the second left fin 252 of each second-tier H-type fin 25 extend from the outer tube 22 in a radial direction thereof toward the inner tube 21 into the accommodation space 23, with each first middle piece 243 extending along the circumferential direction of the inner tube 21 to connect the corresponding first left fin 242 on the left and the corresponding first right fin 241 on the right, each second middle piece 253 extending along the circumferential direction of the outer tube 22 to connect the corresponding second left fin 252 on the left and the corresponding second right fin 251 on the right, and each connecting piece 26 extending along a radial direction of the circular tube with concentric tube walls to connect the corresponding first middle piece 243 and the corresponding second middle piece 253.

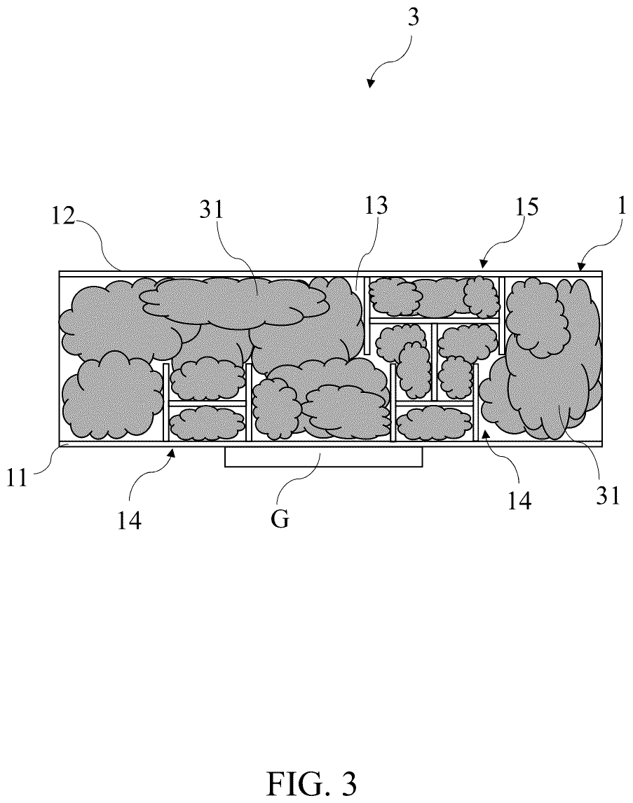

Referring to FIG. 3, yet another mode of implementing the present invention brings about a thermal energy storage device 3 that uses the foregoing heat transfer structure 1 with an improved thermal convection effect. The thermal energy storage device 3 includes: the heat transfer structure 1; and a phase-change material 31 that is provided in the accommodation space 13 between the part 12 far away from the heat source and the part 11 close to the heat source and is in contact with the first-tier H-type fins 14, the connecting piece 16, and the second-tier H-type fin 15, wherein the phase-change material 31 absorbs or releases a large amount of latent heat during a phase change. The thermal energy storage device 3 in this embodiment can be applied to a graphics processing unit (GPU) G in order to absorb the thermal energy generated by the graphics processing unit G and thereby produce a heat dissipation effect. In other words, the thermal energy storage device 3 can be used as a heat sink to prevent a device from overheating.

In some embodiments, the phase-change material 31 may be selected from an organic substance (e.g., paraffin or a non-paraffin organic substance), an inorganic substance (e.g., a hydrate of a salt, a molten salt, or a metal alloy), and a eutectic substance (e.g., a mixture of two organic substances, a mixture of two inorganic substances, or a mixture of an organic substance and an inorganic substance). In this embodiment, the phase-change material 31 is paraffin, a fatty acid, or a hydrate of a salt.

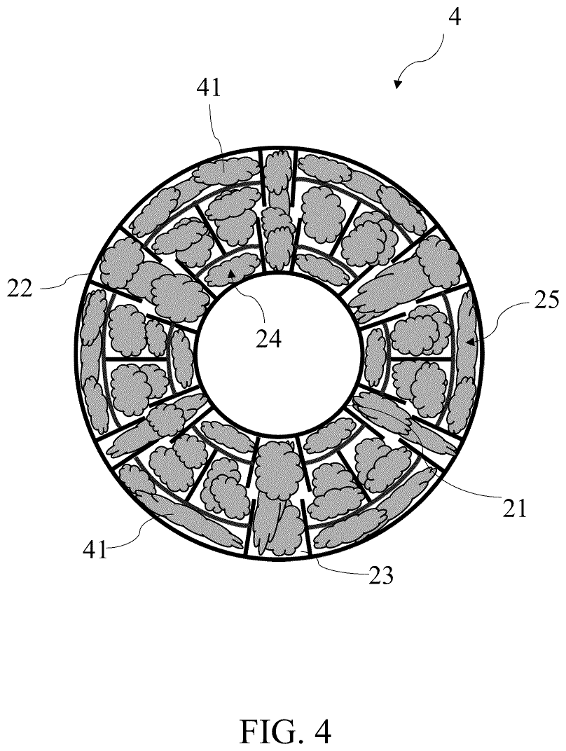

Referring to FIG. 4, still another mode of implementing the present invention brings about a thermal energy storage device 4 that uses the foregoing heat transfer structure 2 with an improved thermal convection effect. The thermal energy storage device 4 includes: the heat transfer structure 2; and a phase-change material 41 that is provided in the accommodation space 23 between the outer tube 22 and the inner tube 21 and is in contact with the first-tier H-type fins 24, the connecting pieces 26, and the second-tier H-type fins 25, wherein the phase-change material 41 absorbs or releases a large amount of latent heat during a phase change.

To verify that the H-type fins in the heat transfer structure of the present invention are indeed conducive to an improved thermal convection effect, a numerical simulation experiment was conducted on the H-type fin structures 27 of the heat transfer structure 2 to simulate the heat flow. The experiment used ANSYS 2022R2 Fluent, a commercial numerical simulation software package, to calculate the two-phase flow field taking place during the melting process of a phase-change material, and the effect of the H-type fin structures 27 in thermal energy storage was verified by the conjugate heat transfer (CHT) method.

Referring back to FIG. 2A, the heat flow numerical simulation experiment was performed on a heat transfer structure 2 with six identical H-type fin structures 27, wherein: the inner tube 21 had a radius of 36.5 mm, the outer tube 22 had a radius of 95 mm, the thickness of the inner tube 21 and the outer tube 22 was 2 mm, the second middle piece 253 of each second-tier H-type fin 25 had a radius of 81 mm and a bending angle represented by the second angle θ2, the first middle piece 243 of each first-tier H-type fin 24 had a radius of 21.5 mm and a bending angle represented by the first angle θ1, each connecting piece 26 had a length of 30 mm, and each first left fin 242, first right fin 241, second left fin 252, and second right fin 251 had a length of 25 mm. The geometric parameters stated above were the basis for the simulation experiment. Besides, the material of the heat transfer structure 2 was aluminum, and the phase-change material was RT-42 for commercial use (manufactured by Rubitherm GmbH). RT-42 is a paraffin-based material and was used in the experiment as a phase-change medium for storing thermal energy. The flow of the simulated/predicted flow field was rapidly and effectively calculated with computational fluid dynamics (CFD) software. The numerical simulation was performed on the H-type fins of the heat transfer structure of the present invention mainly by varying the fin thickness and the bending angles of the second-tier H-type fins 25 and of the first-tier H-type fins 24 as the key parameters affecting the thermal convection effect, and the simulation results are detailed as follows.

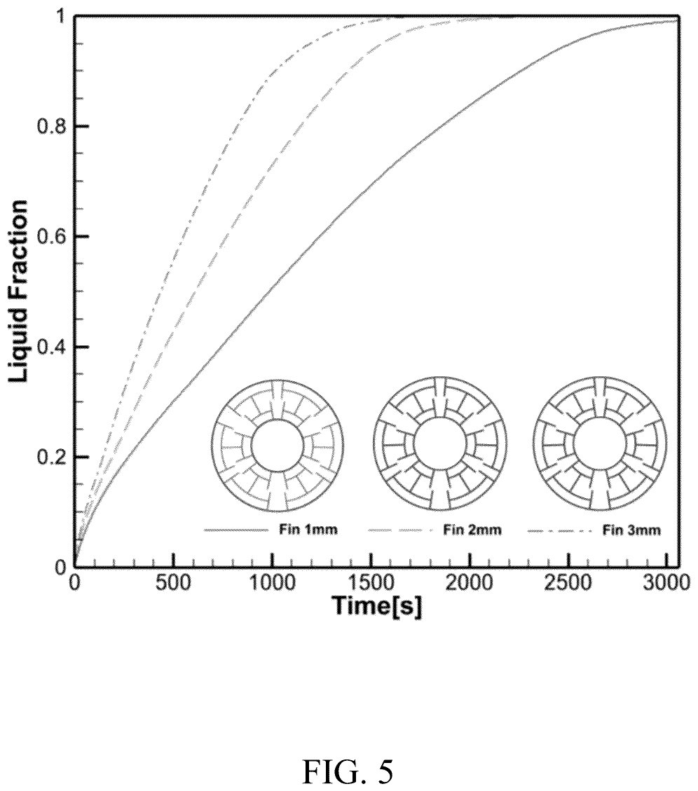

First, referring to FIG. 5, the melting speeds corresponding to three different fin thicknesses (1 mm, 2 mm, and 3 mm) were compared with one another while the bending angle parameters were fixed (the second angle θ2=23°, the first angle θ1=19°). Initially, the phase-change material was melted at similar speeds in all the three cases. After 200 seconds, however, the melting speeds corresponding to the 1-mm and 2-mm thicknesses began to decrease and were lower than the melting speed in the case with the 3-mm thickness. The case with the 1-mm thickness had the poorest heat transfer performance because of the smallest thickness, which resulted in the lowest melting speed; in other words, the thickness limited the heat transfer rate and reduced the melting speed. By contrast, the case with the 3-mm thickness had the largest surface area for heat transfer and hence the highest melting speed, showing also an increase in the distance of heat transfer. Table 1 below and FIG. 5 show the phenomenon that the melting speed of the phase-change material increased with the surface area of the heat transfer structure.

TABLE 1

| Fin thickness | Fin area (mm²) |
|---|---|
| 1 mm | 2541.53 |
| 2 mm | 3389.32 |
| 3 mm | 5757.1 |

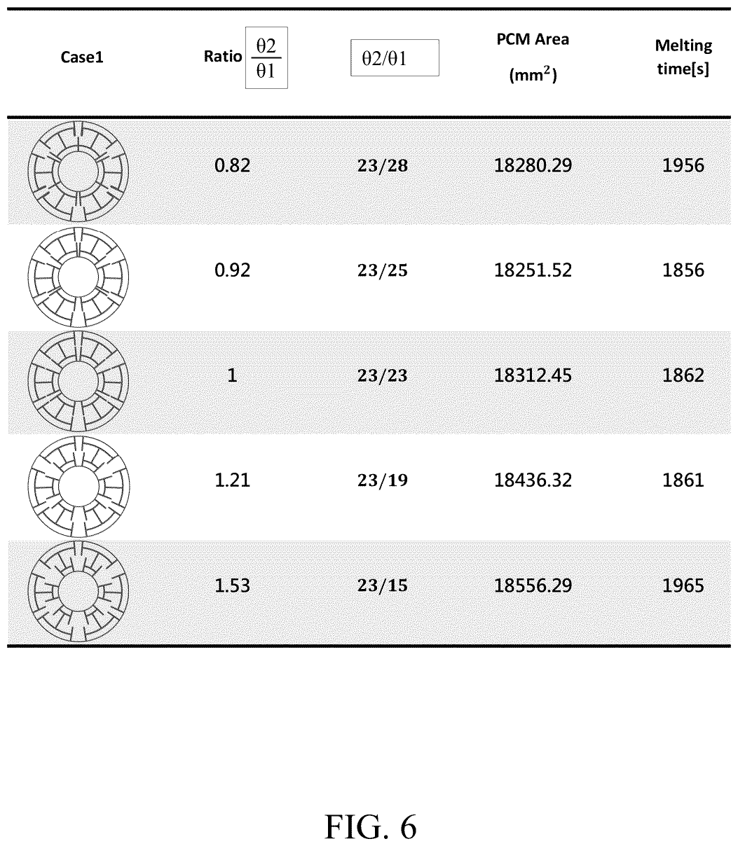

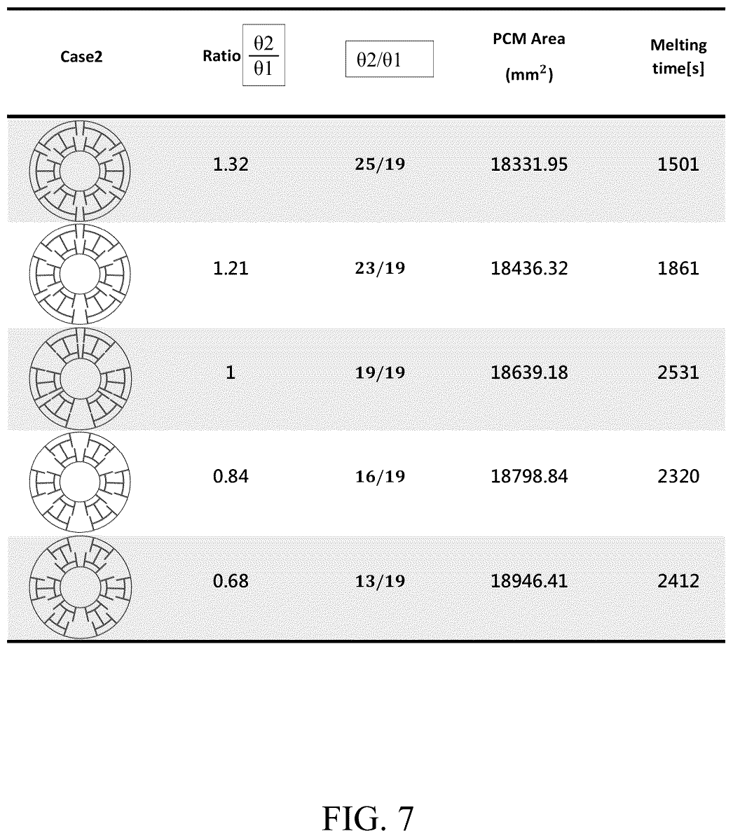

Second, in order to find out how the second-tier H-type fins 25 and the first-tier H-type fins 24 affect heat transfer by the thermal energy storage system, an experiment was conducted to determine how the ratio of the bending angle of each second-tier H-type fin 25 to the bending angle of the corresponding first-tier H-type fin 24 affects the thermal convection effect. Two cases were designed for the experiment. In case 1, referring to FIG. 6, the first angle θ1 was varied in the range from 15° to 28° while the second angle θ2 was fixed at 23°. In case 2, referring to FIG. 7, the first angle θ1 was varied in the range from 12° to 25° while the second angle θ2 was fixed at 19°. Simulation was carried out using the fin thickness of 3 mm in both cases.

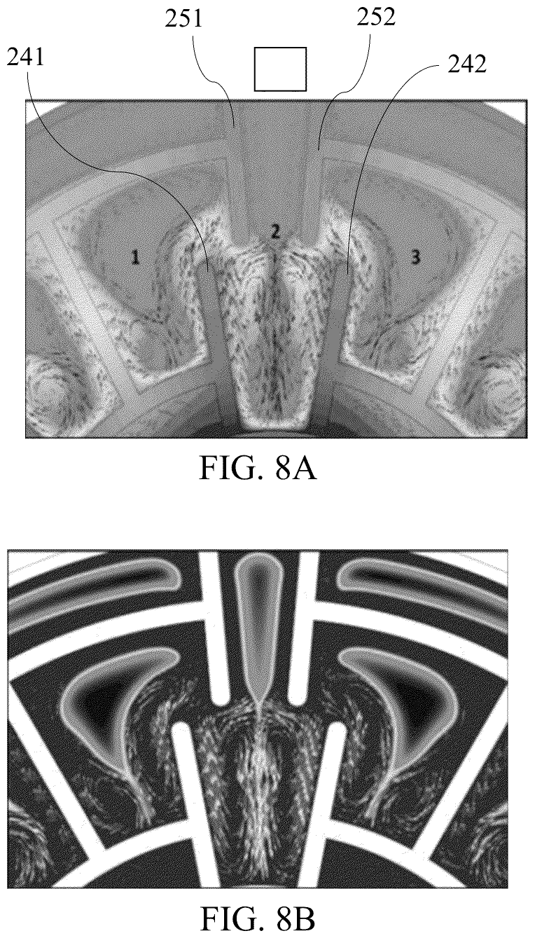

Referring to FIG. 8A and FIG. 8B in conjunction with FIG. 2B, FIG. 8A and FIG. 8B show the results of numerical simulations performed on the fin structures in FIG. 2B, with FIG. 8A being a flow vector and temperature distribution diagram and FIG. 8B being a liquid phase distribution diagram. It can be seen in the flow vector diagram that there were many convection cells (also known as Rayleigh-Bénard convection cells) in the three half-closed convection areas (designated by 1, 2, and 3 in FIG. 8A) formed between the second-tier H-type fins 25 and the first-tier H-type fins 24. This phenomenon occurred under the following conditions: the ratio of the second angle θ2 to the first angle θ1 was 1.32 (i.e., θ2/θ1=1.32), and the time elapsed was 825 seconds. The temperature of the first-tier H-type fins 24, which were close to the surface of the inner tube 21, was higher than the temperature of the second-tier H-type fins 25, and it was this radial temperature gradient that encouraged the formation of the multiple convection cells in the three half-closed convection areas. More specifically, the phase-change material adjacent to the lower half of each fin generated a buoyancy force when heated. Meanwhile, the upper half of each fin had a relatively low temperature and therefore produced a cooling effect, causing a movement of fluid, with the relatively high-temperature low-density fluid flowing upward along the inclined radial fins. As the upper half of each fin had a relatively low temperature and consequently a fluid cooling effect, the fluid reaching the upper half of each fin underwent an increase in density and therefore descended to a bottom area. The foregoing process created a unique convection mode. In areas where both temperature and the fluid moving speed were relatively low, however, the formation of vortices was reduced, so heat transfer took place mainly by thermal conduction. The multiple blue areas in the liquid phase distribution diagram of FIG. 8(B) indicate solid-state phase-change material that was not yet melted and therefore had a zero flow speed.

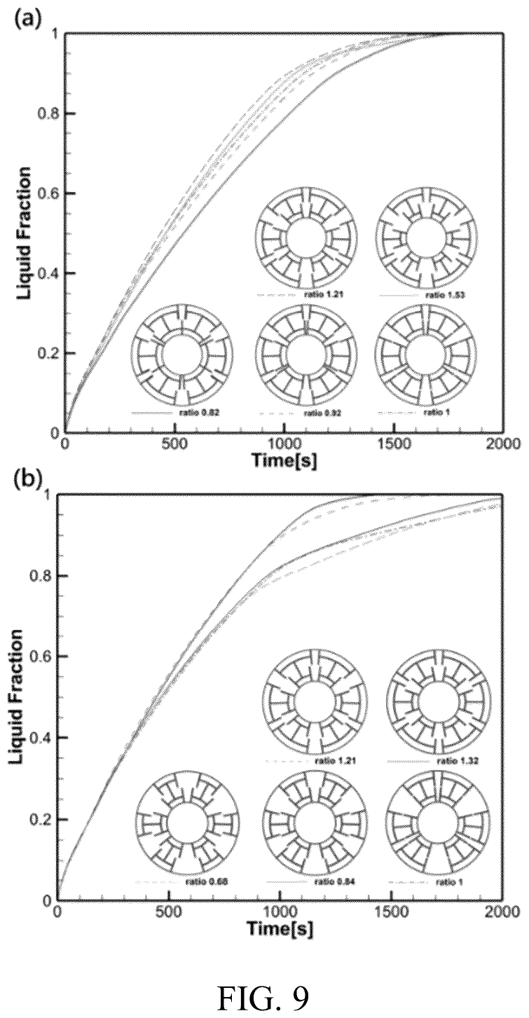

FIG. 9 shows how the melting speed varied with the bending angles in case 1 and case 2. The detailed data is presented in FIG. 6 and FIG. 7. In case 1, the second angle θ2 was 23°, and the total melting time corresponding to the fin structures with the ratio 0.92 was 1856 seconds. Compared with the fin structures with the other ratios in case 1, namely 0.82, 1, 1.21, and 1.53, the fin structures with the ratio 0.92 gave rise to a 5.3%, 0.32%, 0.27%, and 5.9% increase in melting speed respectively. In case 2, the second angle θ2 was 19°, and the total melting time corresponding to the fin structures with the ratio 1.32 was 1501 seconds. Compared with the fin structures with the other ratios in case 2, namely 1.21, 1, 0.84, and 0.68, the fin structures with the ratio 1.32 gave rise to a 24%, 68.6%, 54.6%, and 60.7% increase in melting speed respectively. The total melting time is generally in direct proportion to the fin area. The results in FIG. 9 show that a decrease in the phase-change material area (PCM area) led to an increase in the fin structure area and consequently a reduction in the total melting time. A closer look at the results corresponding to the ratios 0.82 and 0.92 in case 1 and to the ratios 1.21 and 1.32 in case 2 nevertheless reveals that an increase in the fin structure area did not necessarily shorten the total melting time. This is because a reduction in the distance between each two adjacent H-type fin structures may result in conditions disadvantageous to natural convection, and it is these disadvantageous conditions that make a relatively small phase-change material area bring about a relatively long total melting time. As far as the H-type fin structures in case 1 and case 2 are concerned, the fin structure designed with the ratio 1.32 in case 2 contributed to strong natural convection and effectively shortened the time required for melting the phase-change material.

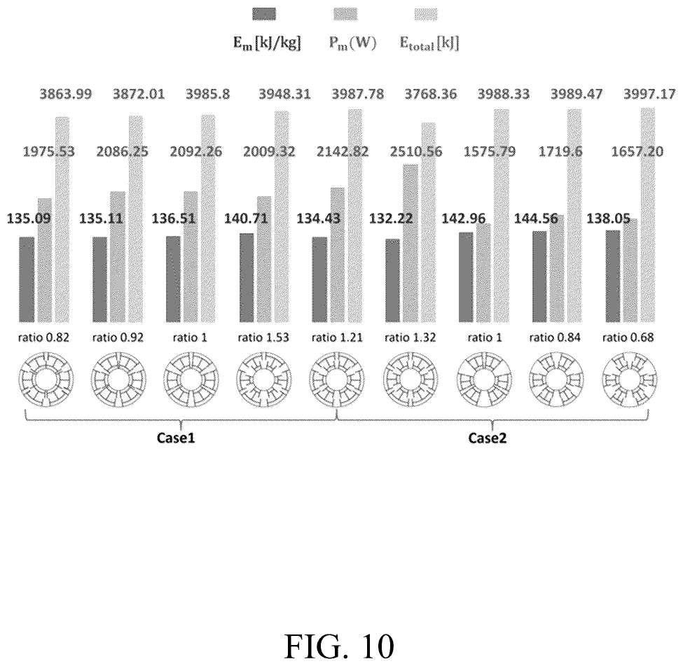

FIG. 10 shows a comparison of the total energy (Eₜₒₜₐₗ), mean power (Pₘ), and energy per unit mass (Eₘ) corresponding to all the ratios in case 1 and case 2. Total energy (Eₜₒₜₐₗ) refers to the total energy that is stored in the phase-change material and the H-type fins and that occupies the total energy capacity of the system. Mean power (Pₘ) is an indicative measurement of melting performance and gives insight into the efficiency with which the PCM undergoes a phase change. Energy per unit mass (Eₘ) is a valuable indicator with which to evaluate the energy storage density of the H-type fin structures and that quantifies the energy stored per unit mass of the system.

In this embodiment, total energy (Eₜₒₜₐₗ) is the sum of latent heat and sensible heat. The fin structures with the ratio 0.68 in case 2 had the highest total energy (Eₜₒₜₐₗ) because, of all the ratios in both cases, this ratio led to the largest phase-change material surface area when the phase-change material was completely melted, and the differences in total energy between the ratio 0.68 and the other ratios, namely 0.82, 0.92, 1, 1.21, 1.53, 1.32, 1, and 0.84 are 3.4%, 3.2%, 0.28%, 0.23%, 1.2%, 6%, 0.22%, and 0.19% respectively.

In this embodiment, mean power (Pₘ) is the ratio of total energy (Eₜₒₜₐₗ) to the total melting time and represents improvement in melting. Mean power (Pₘ) was affected greatly by the positions of the H-type fins. Of all the ratios in case 1 and case 2, the ratio 1.32 led to the highest mean power, and the differences in mean power between the ratio 1.32 and the other ratios, namely 0.82, 0.92, 1, 1.53, 1.21, 1, 0.84, and 0.68, are 27%, 20%, 19%, 24.9%, 17%, 59%, 46%, and 51% respectively.

In this embodiment, energy per unit mass (Eₘ) indicates the energy per unit mass. During the heat transfer process, energy per unit mass (Eₘ) was limited mainly by material properties and the volumes of the PCM and of the aluminum fins. The solid aluminum fins, though takin up less space than the PCM, had a higher density than the PCM, so the total mass of the fin structures was not to be ignored. In case 1 and case 2, energy per unit mass (Eₘ) was not the same across all the ratios. The different proportions between the H-type fin structures and the PCM had an indirect effect on the temperature distributions according to which energy per unit mass was determined in the end. This is why the aforesaid structural factors had to be taken into account when evaluating the heat transfer process of the H-type fin structures defined above.

It can be known from the foregoing disclosure, including the simulation results, that the present invention has the following technical features:

1. Due to an increase in fin area, an increase in fin thickness can shorten the melting time of a phase-change material. Compared with the H-type fin structures having the 1-mm fin thickness, the H-type fin structures having the 3-mm fin thickness reduced the total melting time by 88%.

2. Natural convection plays an important role in heat transfer by the radially disposed H-type fin structures described above. The outer tier of each H-type fin structure has a lower temperature than the inner tier, which is close to the heat source, and this temperature difference creates an environment advantageous to natural convection.

3. Rayleigh-Bénard convection cells were observed in the aforesaid circular tubes that had concentric tube walls and the H-type fin structures. These cells gave rise to an even larger number of split-flow cells that helped reduce the total melting time and improve melting performance.

4. As to the bending angles, the second angle θ2 being greater than the first angle θ1 not only contributes to the formation of natural convection, but also makes more room for thermal convection flow. This helps increase the melting speed of a phase-change material and improve the overall heat transfer efficiency.

5. Changing the two bending angles of an H-type fin structure causes changes in the phase-change material area and volume, and these changes, in turn, directly result in changes in the total energy (Eₜₒₜₐₗ) stored in a circular tube that has concentric tube walls and such H-type fin structures. The ratio 0.68 brought about a relatively large phase-change material area and volume that allowed the phase-change material to store a relatively large amount of thermal energy.

6. The bending angles, which are represented by the second angle θ2 and the first angle θ1, are key to natural convection because changes in the bending angles will affect mean power (Pₘ) and the time required for melting a phase-change material. The ratio 1.32 in case 2 led to an excellent heat transfer rate and consequently the highest mean power (Pₘ).

Based on the findings stated above, it is feasible to apply the H-type fin structure of the present invention and a phase-change material to a latent-heat thermal energy storage (LHTES) system. To increase the heat transfer efficiency or the total energy capacity of the system, it is required to design the arrangement of the H-type fin structure in space properly. If the main objective is to maximize the total energy stored, the ratio 1.21 will be the most appropriate. Conversely, if the objective is to reach the highest total energy per unit mass, the ratio 1 in case 2 will be the preferred design option. To achieve the shortest total melting time, however, the preferred design option will be the ratio 1.32 in case 2. In short, a ratio in the range from 1 to 1.32 is preferred. The design of the arrangement of the H-type fin structure has a critical effect on an LHTES system that includes a phase-change material.

According to the above, the disclosed heat transfer structure with an improved thermal convection effect is such that the external shape the H-type fin structure is specially designed to increase the area of contact for heat exchange, and that by arranging a plurality of such H-type fin structures between the concentric tube walls of a circular tube, relatively strong natural convection can be effectively generated to accelerate the melting of a phase-change material, thereby solving the drawbacks of a conventional LHTES system, namely slow natural convection and low efficiency in heating a phase-change material.

The foregoing description and the accompanying drawings are directed only to some preferred embodiments of the present invention and are not intended to be restrictive of the scope of the patent protection sought by the applicant. Any equivalent change or modification that is made by a person skilled in the art using the technical features of the invention shall fall within the scope of the invention.

What is claimed is:

1. A heat transfer structure with an improved thermal convection effect, comprising:
a part close to a heat source, wherein the part close to the heat source is configured to receive thermal energy from the heat source;
a part far away from the heat source, wherein the part far away from the heat source is located opposite the part close to the heat source such that an accommodation space is formed between the part far away from the heat source and the part close to the heat source; and
a first-tier H-type fin provided in the accommodation space, wherein the first-tier H-type fin is adjacent to the part close to the heat source and is connected to the part close to the heat source, and the first-tier H-type fin comprises:
a first right fin connected to the part close to the heat source;
a first left fin connected to the part close to the heat source, wherein the first left fin and the first right fin are located opposite each other in a left-right direction; and
a first middle piece connecting the first left fin and the first right fin.

2. The heat transfer structure of claim 1, further comprising:
a second-tier H-type fin provided in the accommodation space and located opposite the first-tier H-type fin, wherein the second-tier H-type fin is adjacent to the part far away from the heat source and is connected to the part far away from the heat source, the second-tier H-type fin is connected to the first-tier H-type fin to form an H-type fin structure, and the second-tier H-type fin comprises:
a second right fin connected to the part far away from the heat source;
a second left fin connected to the part far away from the heat source, wherein the second left fin and the second right fin are located opposite each other in the left-right direction; and
a second middle piece connecting the second left fin and the second right fin.

3. The heat transfer structure of claim 2, further comprising:
a connecting piece connecting the first-tier H-type fin and the second-tier H-type fin and located between the first-tier H-type fin and the second-tier H-type fin, wherein the first-tier H-type fin, the connecting piece, and the second-tier H-type fin jointly form the H-type fin structure.

4. The heat transfer structure of claim 3, further comprising:
at least one first reinforcing piece connecting the first middle piece of the first-tier H-type fin and the part close to the heat source and located between the first middle piece and the part close to the heat source; and/or
at least one second reinforcing piece connecting the second middle piece of the second-tier H-type fin and the part far away from the heat source and located between the second middle piece and the part far away from the heat source.

5. The heat transfer structure of claim 3, wherein:
the first middle piece has a length less than a length of the second middle piece; and/or
a distance between orthographic projections of the second left fin and of the second right fin in a normal direction of, and onto, the part close to the heat source is greater than a distance between orthographic projections of the first left fin and of the first right fin in the normal direction of, and onto, the part close to the heat source.

6. The heat transfer structure of claim 3, wherein the first right fin of the first-tier H-type fin and the connecting piece form a first angle therebetween, the second right fin of the second-tier H-type fin and the connecting piece form a second angle therebetween, and the first angle is less than the second angle.

7. The heat transfer structure of claim 2, wherein the part close to the heat source is an inner tube, the part far away from the heat source is an outer tube, the inner tube is provided in the outer tube, the outer tube and the inner tube form an annular space therebetween, the H-type fin structure is provided in the annular space, the outer tube and the inner tube are coaxial and are concentrically arranged, and the outer tube and the inner tube jointly form a circular tube with concentric tube walls.

8. The heat transfer structure of claim 3, wherein the part close to the heat source is an inner tube, the part far away from the heat source is an outer tube, the inner tube is provided in the outer tube, the outer tube and the inner tube form an annular space therebetween, the H-type fin structure is provided in the annular space, the outer tube and the inner tube are coaxial and are concentrically arranged, and the outer tube and the inner tube jointly form a circular tube with concentric tube walls.

9. The heat transfer structure of claim 4, wherein the part close to the heat source is an inner tube, the part far away from the heat source is an outer tube, the inner tube is provided in the outer tube, the outer tube and the inner tube form an annular space therebetween, the H-type fin structure is provided in the annular space, the outer tube and the inner tube are coaxial and are concentrically arranged, and the outer tube and the inner tube jointly form a circular tube with concentric tube walls.

10. The heat transfer structure of claim 5, wherein the part close to the heat source is an inner tube, the part far away from the heat source is an outer tube, the inner tube is provided in the outer tube, the outer tube and the inner tube form an annular space therebetween, the H-type fin structure is provided in the annular space, the outer tube and the inner tube are coaxial and are concentrically arranged, and the outer tube and the inner tube jointly form a circular tube with concentric tube walls.

11. The heat transfer structure of claim 6, wherein the part close to the heat source is an inner tube, the part far away from the heat source is an outer tube, the inner tube is provided in the outer tube, the outer tube and the inner tube form an annular space therebetween, the H-type fin structure is provided in the annular space, the outer tube and the inner tube are coaxial and are concentrically arranged, and the outer tube and the inner tube jointly form a circular tube with concentric tube walls.

12. The heat transfer structure of claim 3, wherein there are N said first-tier H-type fins, N said connecting pieces, and N said second-tier H-type fins so as to form N said H-type fin structures, where N is a positive integer greater than one.

13. The heat transfer structure of claim 8, wherein the first right fin of each said first-tier H-type fin and a corresponding said first left fin of an adjacent said first-tier H-type fin form a third angle therebetween, the second right fin of each said second-tier H-type fin and a corresponding said second left fin of an adjacent said second-tier H-type fin form a fourth angle therebetween, and the third angle is greater than the fourth angle.

14. A thermal energy storage device, comprising:
the heat transfer structure of claim 2; and
a phase-change material provided in the accommodation space between the part far away from the heat source and the part close to the heat source, wherein the phase-change material contacts the first-tier H-type fin and the second-tier H-type fin.
